(19) United States
(12) Patent Application Publication
(10) Pub. No.: US 2022/0017784 A1
(43) Pub. Date: Jan. 20, 2022

(54) RELEASE INKJET PRINTING INK ARTICLES

(71) Applicant: 3M INNOVATIVE PROPERTIES COMPANY, St. Paul, MN (US)

(72) Inventors: Taylor J. Kobe, Woodbury, MN (US); Joel A. Getschel, Osceola, WI (US); Duane D. Fansler, Dresser, WI (US)

(21) Appl. No.: 17/309,594

(22) PCT Filed: Dec. 11, 2019
(86) PCT No.: PCT/IB2019/060662

§ 371 Date: Jun. 9, 2021

Related U.S. Application Data
(60) Provisional application No. 62/778,628, filed on Dec. 12, 2018.

(51) Int. Cl. C09J 7/20; B41M 7/00; B41M 5/50; C09D 11/101; C09D 11/107; C09D 11/30; C09J 7/25

(52) U.S. Cl. CPC C09J 7/201; B41M 7/0018; B41M 5/502; C09D 11/101; C09D 11/107; C09J 2483/005; C09J 7/255; C09J 7/203; C09J 2433/005; C09J 2467/006; C09D 11/30

(57) ABSTRACT

An article and a method of making thereof. The article includes a polymeric film having a first major surface and a second major surface; a first plurality of domains of a first inkjet printing ink comprising a first low adhesion backsize coating composition deposited on the first major surface of the polymeric film; and a second plurality of domains of a second inkjet printing ink comprising a second low adhesion backsize coating composition deposited on the first major surface of the polymeric film; wherein the first and second low adhesion backsize coating composition has a viscosity between 1 to 30 cp at a printing temperature between 20 to 70 degrees Celsius; and wherein at least some of the first plurality of domains overlaps some of the second plurality of domains.

### FIELD OF THE INVENTION

This invention relates to inkjet printing inks, articles using inkjet printing inks and method thereof.

### BACKGROUND

Repositionable note pads, tapes and linerless labels typically consist of sheets of stock (paper, films, etc.) coated with pressure sensitive adhesive (“PSA”) (and optionally a primer) on one side of the sheet and a release coating (also referred to as “low adhesion backsize” or “LAB”) on the other side. In either pad (stacked sheets) or roll form, the release coating is in contact with the adhesive.

Lithographic, flexographic, or gravure printing processes are often used to prepare printed repositionable notes, tapes and linerless labels. Often, the printing process is separate from and subsequent to the process that applies the adhesive and release coating. In such situations, a roll of stock that has been pre-coated with adhesive and a release material is routed through a printing press, ink is printed on top of the release coating, and the printed material is immediately either rolled back up or cut into a stack of discrete sheets. Printing of ink over the release coating renders the release coating ineffective. Undesirable adhesive-ink interactions are also formed which results in poor release (high unwind, tear outs, poor dispensing) and transfer of ink from the printed stock to the adhesive. Such “ink transfer” damages the printed image and contaminates the adhesive. There is a need for inkjet printing inks with LAB coating.

### SUMMARY

Briefly in one aspect of the present invention, an article is provided comprising: a polymeric film having a first major surface and a second major surface; and a plurality of discrete domains of an inkjet printing ink comprising a low adhesion backsize coating composition deposited on the first major surface of the polymeric film. The low adhesion backsize coating composition has a viscosity between 1 to 30 cp at a printing temperature between 20 to 70 degrees Celsius.

Inkjet printing ink comprising a low adhesion backsize coating composition can be advantageously used in products that have pressure sensitive adhesives (PSAs) in contact with the printed inks in order to reduce undesirable PSA/ink interactions. The Inkjet printing ink can add unlimited colors, and colored patterns to the tape backing if desired. Inkjet printing allows for the ability to change these colors, or colored patterns, on the backing without shutting the line down. Printing an LAB will allow a tape backing to have multi designs or patterns in one roll of tape if desired. A printable ink with LAB properties combines the printing and LAB coating steps. This has the process simplification advantage of combining two steps into one step, but also enables printing during the converting process without disrupting current high volume manufacturing.

Thus, in one aspect, the present disclosure provides an article. The article includes a polymeric film having a first major surface and a second major surface; a first plurality of domains of a first inkjet printing ink comprising a first low adhesion backsize coating composition deposited on the first major surface of the polymeric film; and a second plurality of domains of a second inkjet printing ink comprising a second low adhesion backsize coating composition deposited on the first major surface of the polymeric film, wherein the first and second low adhesion backsize coating composition has a viscosity between 1 to 30 cp at a printing temperature between 20 to 70 degrees Celsius; and wherein at least some of the first plurality of domains overlaps some of the second plurality of domains.

In another aspect, the present disclosure provides a method. The method includes providing a polymeric film having a first major surface and a second major surface; depositing a first inkjet printing ink comprising a first low adhesion backsize coating composition onto the first major surface of the polymeric film; and depositing a second inkjet printing ink comprising a second low adhesion backsize coating composition onto the first major surface of the polymeric film; curing the first and second inkjet printing ink to form a first plurality of domains of the first inkjet printing ink and a second plurality of domains of the second inkjet printing ink.

Various aspects and advantages of exemplary embodiments of the present disclosure have been summarized. The above Summary is not intended to describe each illustrated embodiment or every implementation of the present disclosure. Further features and advantages are disclosed in the embodiments that follow. The Drawings and the Detailed Description that follow more particularly exemplify certain embodiments using the principles disclosed herein.

### Definitions

For the following defined terms, these definitions shall be applied for the entire Specification, including the claims, unless a different definition is provided in the claims or elsewhere in the Specification based upon a specific reference to a modification of a term used in the following definitions:

The terms “about” or “approximately” with reference to a numerical value or a shape means +/−five percent of the numerical value or property or characteristic, but also expressly includes any narrow range within the +/−five percent of the numerical value or property or characteristic as well as the exact numerical value. For example, a temperature of “about” 100° C. refers to a temperature from 95° C. to 105° C., but also expressly includes any narrower range of temperature or even a single temperature within that range, including, for example, a temperature of exactly 100° C. For example, a viscosity of “about” 1 Pa-sec refers to a viscosity from 0.95 to 1.05 Pa-sec, but also expressly includes a viscosity of exactly 1 Pa-sec. Similarly, a perimeter that is “substantially square” is intended to describe a geometric shape having four lateral edges in which each lateral edge has a length which is from 95% to 105% of the length of any other lateral edge, but which also includes a geometric shape in which each lateral edge has exactly the same length.

The term “substantially” with reference to a property or characteristic means that the property or characteristic is exhibited to a greater extent than the opposite of that property or characteristic is exhibited. For example, a substrate that is “substantially” transparent refers to a substrate that transmits more radiation (e.g. visible light) than it fails to transmit (e.g. absorbs and reflects). Thus, a substrate that transmits more than 50% of the visible light incident upon its surface is substantially transparent, but a substrate that transmits 50% or less of the visible light incident upon its surface is not substantially transparent.

The terms “a”, “an”, and “the” include plural referents unless the content clearly dictates otherwise. Thus, for example, reference to a material containing “a compound” includes a mixture of two or more compounds.

### BRIEF DESCRIPTION OF THE DRAWINGS

The disclosure may be more completely understood in consideration of the following detailed description of various embodiments of the disclosure in connection with the accompanying FIGURES, in which:

FIG. 1 is a side, cross-sectional view of an article according to one exemplary embodiment.

While the above-identified drawings, which may not be drawn to scale, set forth various embodiments of the present disclosure, other embodiments are also contemplated, as noted in the Detailed Description. In all cases, this disclosure describes the presently disclosed invention by way of representation of exemplary embodiments and not by express limitations. It should be understood that numerous other modifications and embodiments can be devised by those skilled in the art, which fall within the scope and spirit of this disclosure.

### DETAILED DESCRIPTION

Before any embodiments of the present disclosure are explained in detail, it is understood that the invention is not limited in its application to the details of use, construction, and the arrangement of components set forth in the following description. The invention is capable of other embodiments and of being practiced or of being carried out in various ways that will become apparent to a person of ordinary skill in the art upon reading the present disclosure. Also, it is understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. It is understood that other embodiments may be utilized and structural or logical changes may be made without departing from the scope of the present disclosure.

As used in this Specification, the recitation of numerical ranges by endpoints includes all numbers subsumed within that range (e.g. 1 to 5 includes 1, 1.5, 2, 2.75, 3, 3.8, 4, and 5, and the like).

Unless otherwise indicated, all numbers expressing quantities or ingredients, measurement of properties and so forth used in the Specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

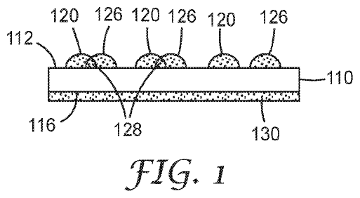

A article according to one embodiment of the invention is illustrated in FIG. 1 and hereinafter referred to by the numeral 100. The article 100 includes a polymeric film 110 having a first major surface 112 and a second major surface 116. A first plurality of domains 120 of a first inkjet printing ink comprising a first low adhesion backsize coating composition deposited on the first major surface 112 of the polymeric film 110. A second plurality of domains 126 of a second inkjet printing ink comprising a second low adhesion backsize coating composition deposited on the first major surface 112 of the polymeric film 110. At least some of the first plurality of domains 120 overlaps some of the second plurality of domains 126. In the overlapped regions 128, the first and second low adhesion backsize coating composition can be present to control functional performance of the article. In some embodiments, the first and second plurality of domains 120 and 126 can have same low adhesion backsize coating composition. In some embodiments, at least part of the first and second plurality of domains 120 and 126 can have different low adhesion backsize coating composition. In some embodiments, all of the first and second plurality of domains 120 and 126 can have different low adhesion backsize coating composition.

In some embodiments, between 1% to 99%, between 5% to 95%, between 10% to 90%, between 20% to 80%, between 30% to 70% or between 40% to 60%, or or in some embodiments, less than, equal to, or greater than 1%, 5%, 10%, 20%, 30%, 40%, 50%, 60%, 70%, 80%, 90%, 95% or 99% of the first plurality of domains 120 and the second plurality of domains 126 are overlapped.

The average space between each domain of the first or second plurality of domains 120 and 126 is between 0 and 50 mils, between 0 and 40 mils, between 0 and 30 mils, between 0 and 25 mils, or in some embodiments, less than, equal to, or greater than 0, 5, 10, 15, 20, 25, 30, 35, 40, 45, 50 mils. In some embodiments, the plurality of discrete domains 120 of an inkjet printing ink can have the same low adhesion backsize coating composition. In some embodiments, at least part of the plurality of discrete domains 120 of an inkjet printing ink can have different low adhesion backsize coating composition. In some embodiments, all of the plurality of discrete domains 120 of an inkjet printing ink can have different low adhesion backsize coating composition. In some embodiments, the average space between each domain of the first and second plurality of domains can be same. In some embodiments, the average space between each domain of the first and second plurality of domains can be different. For example, the average space between each domain of the first plurality of domains can be 20 mils and the average space between each domain of the second plurality of domains can be 50 mils

The the first and second plurality of domains 120 and 126 of an inkjet printing ink can cover 1% to 99%, 5% to 95%, 10% to 90%, 20% to 80%, 30% to 70%, 40% to 60% of the first major surface, or in some embodiments, less than, equal to, or greater than 1%, 2%, 3%, 4%, 5%, 10%, 15%, 20%, 25%, 30%, 35%, 40%, 45%, 50%, 60%, 70%, 80%, 90%, 95%, %%, 97%, 98% or 99% of the first major surface.

The first or second low adhesion backsize coating composition can include a silicone copolymers, for example, crosslinking polysiloxanes. One class of silicone copolymers that provide good properties for UV-curable inks are acrylate terminated silicones (“silicone macromers”), for example methacrylate-terminated poly(dimethylsiloxane). An example of such materials is Silicone “Plus” HG-10 Siloxane, which is commercially available from 3M Company, St. Paul, Minn. Silicone “Plus” HG-10 is a methacrylate terminated poly(dimethylsilicone) polymer having a number average molecular weight of 10,000. Another class of of silicone copolymers can include poly(dimethylsiloxane), poly(dimethylsiloxane-co-diphenylsiloxane), poly(methylphenylsiloxane-co-diphenylsiloxane), and poly(dimethylsiloxane-co-methylphenylsiloxane). Siloxane polymers useful m the practice of this invention may be prepared by any of a number of methods familiar to those skilled in the art, including, for example, anionic, condensation, or ring-opening polymerization. Siloxane polymers useful for this invention may also be prepared with the introduction of functional end-groups or functional pendant groups. This may be accomplished through the use of functional monomers, functional initiators, or functional chain terminators, for example, divinyl terminated poly(methylphenylsiloxane-co-diphenylsiloxane).

The first or second low adhesion backsize coating composition can include acrylates. Suitable acrylates can include, but are not limited to Mono(meth)acrylates, Di(meth)acrylates, aliphatic (meth)acrylates, 2-Hydroxyethyl acrylate, Dipropylene Glycol Diacrylate, 2-Phenoxyethyl acrylate, and fluorinated (meth)acrylates.

The first or second low adhesion backsize coating composition can can include inkjet inks. Preferable inkjet inks are curable by UV irradiation. Suitable inkjet inks can include Type-G DICE Gammajet ink (Prototype and Production Systems Inc. Plymouth, Minn.), UV Clear ink (Kao Collins Inc., Cincinnati, Ohio), Liojet® AP-Series ink (Toyo Ink America, Wood Dale, Ill.), UV Inkjet Ink 1500 Series ink (3M Co. St. Paul, Minn.), and UV Ink LH-Clear ink (Mimaki USA, Inc., Suwanee, Ga.).

The first or second low adhesion backsize coating composition can include fluorinated acrylate monomer used for release liners. Suitable fluorinated acrylate monomer can include LTM Diacrylate (3M Co. St. Paul, Minn.) and A1330, B2340, B5278, B5785, D4989, H1554 (TCI America, Portland. Oreg.).

The first or second low adhesion backsize coating composition can include UV photoinitiator. Suitable UV photoinitiator can include those described in U.S. Pat. No. 340,408, for example Daracur TPO & TPO-L, Irgacure 651, Irgacure 184, Irgacure 819 (Ludwigshafen DE), Esacure KB-1 and IGM.

In order to be suitable for inkjet printing, the first or second low adhesion backsize coating composition has a viscosity between 1 to 30 cp, between 5 to 25 cp, between 10 to 20 ep, or in some embodiments, less than, equal to, or greater than 1, 2, 5, 10, 15, 20, 25, 30 cp at a printing temperature between 20 to 70 degrees Celsius.

The inkjet printing ink can lower the force required to remove the ink from the adjacent sheet in order to facilitate dispensing and minimize stock deformation or curl. The release force for the polymeric film with the inkjet printing ink released from the adjacent polymeric film can be from 10 g/in to 1000 g/in, from 15 g/in to 900 g/in, from 20 g/in to 800 g/in, from 30 g/in to 700 g/in, from 40 g/in to 600 g/in, from 50 g/in to 500 g/in, or in some embodiments, less than or equal to, 1000, 900, 800, 700, 600, 500, 400, 300, 200, 100, 50, 40, 30, 20 g/in.

In some embodiments, the polymeric film can be selected from polyolefins, halogenated polyolefins, polyamides, polytetrafluoroethylene, polyacrylates, polystyrenes, nylon, polyesters, polyester copolymers, polyurethanes, polysulfones, styrene-maleic anhydride copolymers, styrene-acrylonitrile copolymers, ionomers based on sodium or zinc salts or ethylene methacrylic acid, polymethyl methacrylates, cellulosics, acrylic polymers and copolymers, polycarbonates, polyacrylonitriles ethylene-vinyl acetate copolymers, and fluoropolymers. In some embodiments, suitable substrate 120 can be conveniently an organic polymeric layer that is processed to be heat-shrinkable by any suitable means. Semicrystalline or amorphous polymers can be made heat-shrinkable by orienting them at a temperature above their glass transition temperature, Tg, and then cooling. Examples of useful semicrystalline polymeric films include polyolefins such as polyethylene (PE), polypropylene (PP), and syndiotactic polystyrene (sPS); polyesters such as polyethylene terephthalate (PET), polyethylene napthalate (PEN), and polyethylene-2,6-naphthalate; fluorpolymers such as polyvinylidene difluoride, and ethylene:tetrafluoroethylene copolymers (ETFE); polyamides such as Nylon 6 and Nylon 66; polyphenylene oxide, and polyphenylene sulfide. Examples of amorphous polymer films include polymethylmethacrylate (PMMA), polyimides (PI), polycarbonate (PC), polyether sulfone (PES), atactic polystyrene (aPS), polyvinyl chloride (PVC), and norbomene based cyclic olefin polymer (COP) and cyclic olefin copolymer (COC). Some polymer materials are available in both semicrystalline and amorphous forms. Semicrystalline polymers such as those listed above can also be made heat-shrinkable by heating to the peak crystallization temperature and cooling. In some embodiments, the polymeric film can be a polyethylene terephthalate film.

In some embodiments, the article can include an adhesive 130 on the second major surface 116 of the polymeric film 110. Suitable adhesive for use in the article includes any adhesive that provides acceptable adhesion. Suitable adhesives can be pressure sensitive and in certain embodiments have a relatively high moisture vapor transmission rate to allow for moisture evaporation. Suitable pressure sensitive adhesives include those based on acrylates, urethane, hyrdogels, hydrocolloids, block copolymers, silicones, rubber based adhesives (including natural rubber, polyisoprene, polyisobutylene, butyl rubber etc.) as well as combinations of these adhesives. The adhesive component may contain tackifiers, plasticizers, rheology modifiers as well as active components including for example an antimicrobial agent. Suitable adhesive can include those described in U.S. Pat. Nos. 3,389,827; 4,112,213; 4,310,509; 4,323,557; 4,595,001; 4,737,410; 6,994,904 and International Publication Nos. WO 2010/056541; WO 2010/056543 and WO 2014/149718, the disclosures of which are hereby incorporated by reference. The adhesive can be processed to form solid, pattern or porous adhesive layer.

A method of making the article of the present application is provided. A polymeric film having a first major surface and a second major surface is provided. A first inkjet printing ink comprising a first low adhesion backsize coating composition can be deposited onto the first major surface of the polymeric film. A second inkjet printing ink comprising a second low adhesion backsize coating composition can be deposited onto the first major surface of the polymeric film. The first and second inkjet printing ink can be cured to form a first plurality of domains of the first inkjet printing ink and a second plurality of domains of the second inkjet printing ink. The inkjet printing ink can be deposited by standard inkjet printing presses. In some embodiments, an adhesive can be applied onto the second major surface of the polymeric film.

A printable ink with LAB properties combines the printing and LAB coating steps. This has the process simplification advantage of combining two steps into one step, but also enables printing during the converting process without disrupting current high volume manufacturing. Printing during converting is advantageous because digital printing is more compatible with converting line speeds and capital investment requirements are much lower. The printable ink with LAB properties of the present applicant has the ability to precisely change (on-demand with inkjet) the release force by controlling the domain density and surface area printed.

The following embodiments are intended to be illustrative of the present disclosure and not limiting.

### Embodiments

1. An article, comprising: a polymeric film having a first major surface and a second major surface; a first plurality of domains of a first inkjet printing ink comprising a first low adhesion backsize coating composition deposited on the first major surface of the polymeric film; and a second plurality of domains of a second inkjet printing ink comprising a second low adhesion backsize coating composition deposited on the first major surface of the polymeric film; wherein the first and second low adhesion backsize coating composition has a viscosity between 1 to 30 cp at a printing temperature between 20 to 70 degrees Celsius; and wherein at least some of the first plurality of domains overlaps some of the second plurality of domains.
2. The article of embodiment 1, wherein the low adhesion backsize coating composition comprises Mono(meth)acrylates, Di(meth)acrylates, aliphatic (meth)acrylates, fluorinated (meth)acrylates, Poly(dimethylsiloxane-co-diphenylsiloxane), divinyl terminated and/or Poly(dimethylsiloxane), mono(meth)acrylate terminated.
3. The article of any one of embodiments 1-2, wherein the polymeric film comprises polyesters, polyolefins, polytetrafluoroethylene, polyvinyl chloride, polycarbonates, polyacrylates, polyurethanes, and/or cellulosic.
4. The article of any one of embodiments 1-3, wherein the polymeric film is a polyethylene terephthalate film.
5. The article of any one of embodiments 1-4, wherein the first and second low adhesion backsize coating compositions are curable.
6. The article of any one of embodiments 1-5, wherein the release force of the polymeric film is from 10 g/in to 1000 g/in.
7. The article of any one of embodiments 1-6, wherein the first low adhesion backsize coating composition is different from the second low adhesion backsize coating composition.
8. The article of any one of embodiments 1-7, further comprising an adhesive on the second major surface of the polymeric film.
9. The article of any one of embodiments 1-8, wherein the first plurality of domains and the second plurality of domains cover 1% to 99% of the first major surface.
10. The article of any one of embodiments 1-9, wherein the average space between each domain of the first plurality of domains or the second plurality of domains is between 0 and 50 mils.
11. The article of any one of embodiments 1-10, wherein between 1% to 99% of the first plurality of domains and the second plurality of domains are overlapped.
12. A method, comprising:

providing a polymeric film having a first major surface and a second major surface;

depositing a first inkjet printing ink comprising a first low adhesion backsize coating composition onto the first major surface of the polymeric film; and

depositing a second inkjet printing ink comprising a second low adhesion backsize coating composition onto the first major surface of the polymeric film;

curing the first and second inkjet printing ink to form a first plurality of domains of the first inkjet printing ink and a second plurality of domains of the second inkjet printing ink.

13. The method of embodiment 12, wherein the low adhesion backsize coating composition has a viscosity between 1 to 30 cp at a printing temperature between 20 to 70 degrees Celsius.
14. The method of any one of embodiments 12-13, further comprising applying an adhesive onto the second major surface of the polymeric film.

The following working examples are intended to be illustrative of the present disclosure and not limiting.

### Examples

### Listing of Starting Materials

HEA 2-hydroxyethyl acrylate

(obtained from Sigma-Aldrich (now MilliporeSigma Chemical) Milwaukee, Wis.)

DPGDA dipropyleneglycol diacrylate

(obtained from Sigma-Aldrich (now MilliporeSigma Chemical) Milwaukee, Wis.)

PEA 2-phenoxyethyl acrylate

(obtained from Sigma-Aldrich (now MilliporeSigma Chemical) Milwaukee, Wis.)

IRGACURE 819 phenylbis(2,4,6-trimethylbenzoyl)phosphine oxide

(obtained under the Tradename IRGACURE 819 from BASF, Ludwigshaven, Del.)

LTM Diacrylatea poly(perfluoroethylene oxide)(perfluoropropylene oxide)α,ω-diacrylate

(obtained from 3M, St. Paul, Minn.)

Poly(dimethylsiloxane-co-diphenylsiloxane), divinyl terminated

(obtained from Sigma-Aldrich (now MilliporeSigma Chemical) Milwaukee, Wis.)

Poly(dimethylsiloxane), monomethacrylate terminated

(obtained from Sigma-Aldrich (now MilliporeSigma Chemical) Milwaukee, Wis.)

ODA octadecyl acrylate

(obtained from Sigma-Aldrich (now MilliporeSigma Chemical) Milwaukee, Wis.)

### Examples 1-4 and Comparative Example C1: Release Adhesion to LAB Ink Formulations

For Examples 1-4, ink formulations A through D, respectively, as shown in Table 1, were coated onto biaxially oriented PET polyester film (obtained under the tradename HOSTAPHAN 3SAB from Mitsubishi Polyester Film, Greer, S.C.) using a #3 Meyer rod and cured with UV light for 30 minutes (UV bulb obtained under the tradename SYLVANIA 350BL, Osram Sylvania, Wilmington, Mass.). The dosage was 1.5 J/cm².

Each of the inks has a viscosity of about 10-15 cps at a printing temperature of 45 C.

TABLE 1
Ink formulations used for release adhesion testing in Examples 1-4

| | | | | | | | Poly(dimethyl- | Poly(dimethyl- |
|---|---|---|---|---|---|---|---|---|
| | | | | | | | siloxane-co- | siloxane), |
| | | | | | | | diphenyl-siloxane), | monometh- |
| | | | | | Irgacure | LTM | divinyl | acrylate |
| | | HEA | DPGDA | PEA | 819 | Diacrylate | terminated | terminated |
| Ex. | Ink | wt % | wt % | wt % | wt % | wt % | wt % | wt % |
| 1 | Ink | 13.64 | 20.09 | 63.60 | 2.67 | | | |
| | A | | | | | | | |
| 2 | Ink | 13.50 | 19.89 | 62.96 | 2.64 | 0.01 | | |
| | B | | | | | | | |
| 3 | Ink | 13.50 | 19.89 | 62.96 | 2.64 | | 0.01 | |
| | C | | | | | | | |
| 4 | Ink | 13.50 | 19.89 | 62.96 | 2.64 | | | 0.01 |
| | D | | | | | | | |

Mending tape (obtained under the tradename SCOTCH 810 MAGIC TAPE from 3M, Saint Paul, Minn.), masking tape (obtained under the tradename SCOTCH 232 MASKING TAPE from 3M, Saint Paul, Minn.), and packaging tape (obtained under the tradenanme 3M 369 PACKAGING TAPE from 3M, Saint Paul, Minn.) were applied to the cured ink coatings of each of Examples 1-4, using a four inch diameter hand-roller, as well as to uncoated polyester film Comparative Example C1. After 30 minutes' time, release adhesion was tested using a peel tester (obtained under the tradename IMASS SP-2100 Slip/Peel Tester from Instrumentors, Inc., Strongsville, Ohio). ASTM test D3330-78 was followed to perform a 180° peel at 12 in/min, employing a 2 sec start time and a 10 sec data collection time. Release adhesion results are shown in Table 2. “PET-Ink Fail” denotes that the peel happened between the ink and the PET, rather than between the ink and the tape. “30+” mean that the machine's measurement limit of 33 oz/in width was exceeded.

TABLE 2
Tape release adhesion results from ink

| | Ex. 1 | Ex. 2 | Ex. 3 | Ex. 4 | Ex. 5 | |
|---|---|---|---|---|---|---|
| | Ink A | Ink B | Ink C | Ink D | PET | |
| | oz/in | oz/in | oz/in | oz/in | (no coating) | |
| | width | width | width | width | oz/in width | |
| Tape | (N/cm) | (N/cm) | (N/cm) | (N/cm) | (N/cm) | |
| Magic | 12.4 | 1.1 | 0.8 | 1.3 | 13 | 1.42) |
| | (1.36) | (0.12) | (0.09) | (0.14) | | |
| Masking | 25.6 | 9.1 | 0.6 | 0.7 | 21.4 | (2.34) |
| | (2.80) | (1.00) | (0.07) | (0.08) | | |
| Packaging | PET-Ink Fail | 9.6 | 1.6 | 1 | 30+ | (3.28+) |
| | | (1.05) | 0.18) | (0.11) | | |

### Example 5-13 and Comparative Examples C2 and C3: Release Adhesion from Printed LAB Ink

Ink formulations E and F, shown in Table 3, were printed using an inkjet printer (obtained under the tradename DIMATIX MATERIALS PRINTER DMP-2831 from Fujifilm Dimatix, Inc., Santa Clara, Calif.) with a cartridge (obtained under the tradename DIMATIX MATERIALS CARTRIDGE DMC-11610 from Fujifilm Dimatix, Inc., Santa Clara, Calif.) onto corona treated biaxially oriented PET polyester film. Air corona treatment was performed at 0.25 J/cm² using a corona treater (obtained from Pillar Technologies, Hartland, Wis.) on a laboratory scale. The same ink formulations were also inkjet printed onto the backside (adhesive strip side) of repositionable note paper (obtained under the tradename POST-IT from 3M, Saint Paul, Minn.), taking care to avoid printing on the adhesive strip. In all cases, the inkjet-printed ink was then cured using an ultraviolet LED source (obtained under the tradename OMNICURE AC475-395 from Excelitas Technologies, Waltham, Mass.) at 1400 mJ/cm² in a nitrogen purged atmosphere. The dot sizes were measured on the corona treated PET and were found to be 84+/−2 microns in diameter, and the dot sizes on POST-IT paper were 39+/−5 microns. The dot size is a function of the drop volume and contact angle. The spacing of the printed ink dots was varied from 50 microns to 250 microns in the various Examples.

TABLE 3
Ink formulations used for printing in Examples 5-13

| | DICE Type G Ink | | | |
|---|---|---|---|---|
| | (obtained from | | | |
| | Prototype and | | | Poly(dimethylsiloxane- |
| | Production Systems, | | LTM | co-diphenylsiloxane), |
| | Inc., Plymouth, MN) | ODA | Diacrylate | divinyl terminated |
| Ink | wt % | wt % | wt % | wt % |
| Ink E | 99.90 | | | 0.10 |
| Ink F | 99.00 | 1.00 | | |
| Ink G | 99.90 | | 0.10 | |

Mending tape (obtained under the tradename SCOTCH 810 MAGIC TAPE from 3M, Saint Paul, Minn.), was applied to the printed and cured ink with a four inch diameter hand-roller as well as to unprinted corona treated polyester film and to the unprinted POST-IT paper (backside). After 30 minutes' time, release adhesion was tested using a peel tester (obtained under the tradename IMASS SP-2100 Slip/Peel Tester from Instrumentors, Inc., Strongsville, Ohio). ASTM test D3330-78 was followed to perform a 180° peel at 12 in/min, employing a 2 sec start time and a 10 sec data collection time. Release adhesion results are shown in Table 4 and Table 5.

TABLE 4
Release adhesion from printed ink on corona
treated polyester film at varied dot spacings

| | | | Adhesion |
|---|---|---|---|
| | | Dot Spacing | oz/in width |
| Example | Ink | μm × μm | (N/cm) |
| C2 | No Ink | (PET Control) | 16.9 |
| | | | (1.85) |
| 5 | Ink E | 50 × 50 | 8.5 |
| | | | (0.93) |
| 6 | Ink E | 100 × 100 | 8.4 |
| | | | (0.92) |
| 7 | Ink E | 150 × 150 | 13.0 |
| | | | (1.42) |
| 8 | Ink E | 200 × 200 | 14.5 |
| | | | (1.59) |
| 9 | Ink E | 250 × 250 | 15.7 |
| | | | (1.72) |

TABLE 5
Release adhesion from printed ink on POST-IT
Note paper at varied dot spacings

| | | | Adhesion |
|---|---|---|---|
| | | Dot Spacing | oz/in width |
| Example | Ink | μm × μm | (N/cm) |
| C3 | No Ink | (POST-IT paper | 17.0 |
| | | Control) | (1.86) |
| 10 | Ink E | 100 × 100 | 7.1 |
| | | | (0.78) |
| 11 | Ink E | 200 × 200 | 13.2 |
| | | | (1.44) |
| 12 | Ink F | 100 × 100 | 7.7 |
| | | | (0.84) |
| 13 | Ink F | 200 × 200 | 12.4 |
| | | | (1.36) |

### Example 14-18: Release Adhesion from Two Printed LAB Inks

Two ink formulations, from Table 3, were inkjet printed and then cured onto corona treated polyester film as described in Example 5-13. The spacing of the printed ink dots was varied from 50 microns to 150 microns. Release adhesion was tested as in the previous Examples. Release adhesion results are shown in Table 6, with Comp. Ex. C2 listed again for comparison.

TABLE 6
Release adhesion from two printed inks on corona
treated polyester at varied dot spacings

| | | | | | Adhesion |
|---|---|---|---|---|---|
| | | Dot Spacing | | Dot Spacing | oz/in width |
| Ex. | Ink 1 | μm × μm | Ink 2 | μm × μm | (N/cm) |
| C2 | No Ink | | No Ink | (PET Control) | 16.9 |
| | | | | | (1.85) |
| 14 | Ink E | 50 × 50 | Ink F | 50 × 50 | 12.3 |
| | | | | | (1.35) |
| 15 | Ink E | 100 × 100 | Ink F | 50 ×50 | 11.9 |
| | | | | | (1.30) |
| 16 | Ink E | 150 × 150 | Ink F | 50 × 50 | 12.9 |
| | | | | | (1.41) |
| 17 | Ink E | 150 × 150 | Ink F | 150 × 150 | 8.7 |
| | | | | | (0.95) |
| 18 | Ink E | 50 × 50 | Ink G | 50 × 50 | 10.7 |
| | | | | | (1.17) |

### Examples 19 and 20: Patterned LAB Inks

To demonstrate that it is possible to spatially pattern where the release adhesion (or other property of the cured inks) is higher or lower (for instance, in order to provide less release adhesion only at an edge of a tape roll), two ink formulations, from Table 3, were inkjet printed onto corona treated polyester film as described in previous Examples in a pattern of alternating 3 mm wide lines, and then cured. For Example 19, lines of Ink E with added cyan pigment were printed at 200 μm×200 μm spacing and lines of Ink F with added cyan pigment were printed at 75 μm×75 μm spacing. For Example 20, lines of Ink E with added yellow pigment were printed at 75 μm×75 μm spacing and lines of Ink E with added cyan pigment were printed at 75 μm×75 μm spacing.

The film of Example 19, so printed, exhibited clearly defined stripes of lighter (less saturated) and darker (more saturated) color. The film of Example 20, so printed, exhibited clearly defined stripes of yellow and cyan color.

All references and publications cited herein are expressly incorporated herein by reference in their entirety into this disclosure. Illustrative embodiments of this invention are discussed and reference has been made to possible variations within the scope of this invention. For example, features depicted in connection with one illustrative embodiment may be used in connection with other embodiments of the invention. These and other variations and modifications in the invention will be apparent to those skilled in the art without departing from the scope of the invention, and it should be understood that this invention is not limited to the illustrative embodiments set forth herein. Accordingly, the invention is to be limited only by the claims provided below and equivalents thereof.

1. An article, comprising:
a polymeric film having a first major surface and a second major surface;
a first plurality of domains of a first inkjet printing ink comprising a first low adhesion backsize coating composition deposited on the first major surface of the polymeric film; and
a second plurality of domains of a second inkjet printing ink comprising a second low adhesion backsize coating composition deposited on the first major surface of the polymeric film;
wherein the first and second low adhesion backsize coating composition has a viscosity between 1 to 30 cp at a printing temperature between 20 to 70 degrees Celsius; and
wherein at least some of the first plurality of domains overlaps some of the second plurality of domains.

2. The article of claim 1, wherein the low adhesion backsize coating composition comprises at least one of Mono(meth)acrylates, Di(meth)acrylates, aliphatic (meth)acrylates, fluorinated (meth)acrylates, Poly(dimethylsiloxane-co-diphenylsiloxane), divinyl terminated, and Poly(dimethylsiloxane), mono(meth)acrylate terminated.

3. The article of claim 1, wherein the polymeric film comprises at least one of polyesters, polyolefins, polytetrafluoroethylene, polyvinyl chloride, polycarbonates, polyacrylates, polyurethanes, and cellulosic.

4. The article of claim 1, wherein the polymeric film is a polyethylene terephthalate film.

5. The article of claim 1, wherein the first and second low adhesion backsize coating compositions are curable.

6. The article of claim 1, wherein the release force of the polymeric film is from 10 g/in to 1000 g/in.

7. The article of claim 1, wherein the first low adhesion backsize coating composition is different from the second low adhesion backsize coating composition.

8. The article of claim 1, further comprising an adhesive on the second major surface of the polymeric film.

9. The article of claim 1, wherein the first plurality of domains and the second plurality of domains cover 1% to 99% of the first major surface.

10. The article of claim 1, wherein the average space between each domain of the first plurality of domains or the second plurality of domains is between 0 and 50 mils.

11. The article of claim 1, wherein between 1% to 99% of the first plurality of domains and the second plurality of domains are overlapped.

12. A method, comprising:
providing a polymeric film having a first major surface and a second major surface;
depositing a first inkjet printing ink comprising a first low adhesion backsize coating composition onto the first major surface of the polymeric film; and
depositing a second inkjet printing ink comprising a second low adhesion backsize coating composition onto the first major surface of the polymeric film;
curing the first and second inkjet printing ink to form a first plurality of domains of the first inkjet printing ink and a second plurality of domains of the second inkjet printing ink.

13. The method of claim 12, wherein the low adhesion backsize coating composition has a viscosity between 1 to 30 cp at a printing temperature between 20 to 70 degrees Celsius.

14. The method of claim 12, further comprising applying an adhesive onto the second major surface of the polymeric film.
